(19) United States
(12) Patent Application Publication
(10) Pub. No.: US 2021/0300439 A1
(43) Pub. Date: Sep. 30, 2021

(54) VEHICLE CONTROL DEVICE

(71) Applicant: HONDA MOTOR CO., LTD., Tokyo (JP)

(72) Inventors: Takashi SHIGIHARA, Tokyo (JP); Yuta KANBE, Tokyo (JP); Masaki NAITO, Tokyo (JP); Soichiro MIYAMOTO, Tokyo (JP)

(21) Appl. No.: 17/194,500

(22) Filed: Mar. 8, 2021

(30) Foreign Application Priority Data
Mar. 26, 2020 (JP) 2020-056570

(51) Int. Cl. B60W 60/00; B60W 30/18; B60W 30/095; B60W 30/09; B60W 30/16; B60W 10/20; H04W 4/46

(52) U.S. Cl. CPC B60W 60/00274; B60W 60/00276; B60W 30/18163; B60W 30/0956; B60W 30/09; B60W 2556/65; B60W 10/20; H04W 4/46; B60W 2554/806; B60W 2554/804; B60W 30/16

(57) ABSTRACT

A vehicle control device mounted on a first vehicle and capable of causing the first vehicle to travel by automated driving, includes a trajectory information obtaining unit configured to obtain information pertaining to a travel trajectory of a second vehicle behind the first vehicle; and a control unit configured to control a position of the first vehicle to a side opposite from the travel trajectory in a road width direction on the basis of the information obtained by the trajectory information obtaining unit.

### CROSS-REFERENCE TO RELATED APPLICATION(S)

This application claims priority to and the benefit of Japanese Patent Application No. 2020-056570 filed on Mar. 26, 2020, the entire disclosure of which is incorporated herein by reference.

### BACKGROUND OF THE INVENTION

### Field of the Invention

The present invention relates to a vehicle control device.

### Description of the Related Art

Techniques which use communication technology such as vehicle-to-vehicle communication or road-to-vehicle communication, or use sensors such as cameras, to detect other vehicles, and implement travel taking into account the other vehicles, have been proposed. For example, Japanese Patent Laid-Open No. 2008-74210 proposes a technique in which a plurality of vehicles are arranged in a staggered manner, in a road width direction with respect to a travel path, and caused to travel in formation.

The occupants of a plurality of vehicles will have different degrees of urgency with which they wish to reach their destinations. When a vehicle hurrying to its destination approaches from the rear, making it possible for that rear vehicle behind the self-vehicle to travel smoothly contributes to realizing smoothly-moving traffic.

### SUMMARY OF THE INVENTION

An object of the present invention is to make it easy for a vehicle behind a self-vehicle hurrying to a destination to travel smoothly.

According to an aspect of the present invention, there is provided a vehicle control device mounted on a first vehicle and capable of causing the first vehicle to travel by automated driving, the device comprising: a trajectory information obtaining unit configured to obtain information pertaining to a travel trajectory of a second vehicle behind the first vehicle; and a control unit configured to control a position of the first vehicle to a side opposite from the travel trajectory in a road width direction on the basis of the information obtained by the trajectory information obtaining unit.

Further features of the present invention will become apparent from the following description of exemplary embodiments (with reference to the attached drawings).

### BRIEF DESCRIPTION OF THE DRAWINGS

FIG. 1 is a block diagram illustrating a vehicle and a control device according to an embodiment.

FIG. 2 is a flowchart illustrating an example of processing executed by a vehicle control device illustrated in FIG. 1.

FIG. 3 is a diagram illustrating an example of vehicle-to-vehicle communication among a plurality of vehicles.

FIG. 4A is a block diagram illustrating a control device of a rear vehicle.

FIG. 4B is a flowchart illustrating an example of processing executed by the control device illustrated in FIG. 4A.

FIG. 5A is a flowchart illustrating an example of processing executed by the vehicle control device illustrated in FIG. 1.

FIG. 5B is a diagram illustrating an example of a setting for a distance Dt.

FIGS. 6A and 6B are explanatory diagrams illustrating an example of the behavior of a plurality of vehicles.

FIGS. 7A and 7B are explanatory diagrams illustrating another example.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

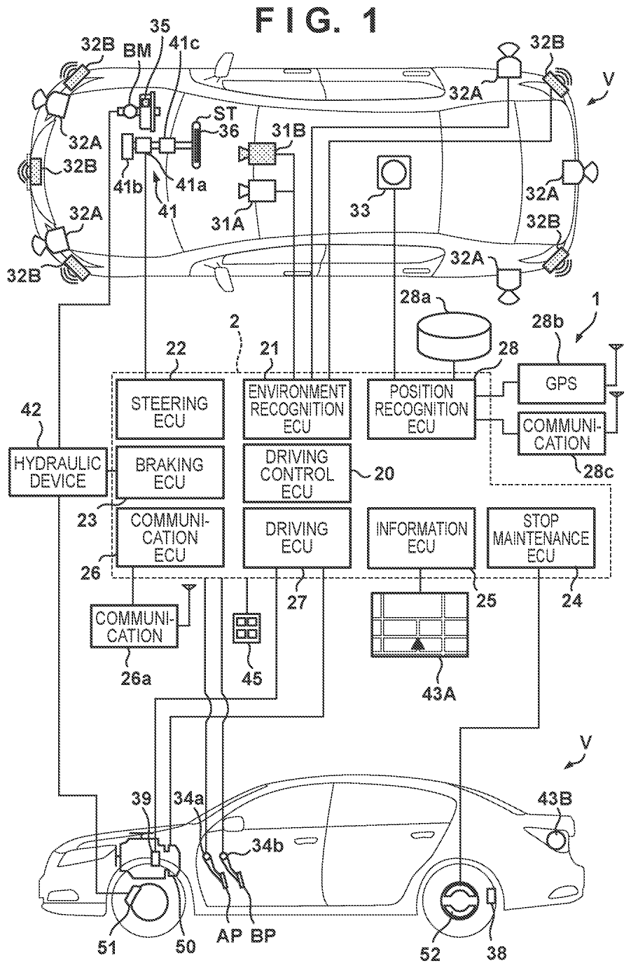

FIG. 1 is a block diagram illustrating a vehicle V and a control device 1 mounted on the vehicle V according to an embodiment of the present invention. An overview of the vehicle V is illustrated in FIG. 1, both as a plan view and as a side view. The vehicle V is, for example, a sedan-type four-wheeled passenger vehicle.

The vehicle V according to the present embodiment is, for example, a parallel-type hybrid vehicle. In this case, a power plant 50, serving as a travel drive unit that outputs drive power for rotating drive wheels of the vehicle V, can include an internal combustion engine, a motor, and an automatic transmission. The motor can be used not only as a drive source when causing the vehicle V to accelerate, but also as an electric generator during deceleration and the like (regenerative braking).

### Control Device

The configuration of the control device 1 of the vehicle V will be described with reference to FIG. 1. The control device 1 includes an ECU group (control unit group) 2. The ECU group 2 includes a plurality of ECUs 20 to 28 configured to be capable of communicating with each other. Each ECU includes a processor such as a CPU, a storage device such as semiconductor memory, an interface with external devices, and the like. The storage device stores programs executed by the processor, the data used in processing by the processor, and so on. Each ECU may include a plurality of processors, storage devices, interfaces, and so on. Note that the number of ECUs, the functions handled by the ECUs, and so on can be designed as appropriate, and can be set at a finer or broader level than that described in the present embodiment. Note also that names of the main functions of the ECUs 20 to 28 are denoted in FIG. 1. For example, the ECU 20 is denoted as a “driving control ECU”.

The ECU 20 executes control pertaining to travel assistance, including automated driving, of the vehicle V. In automated driving, powering the vehicle V (causing the vehicle V to accelerate and the like using the power plant 50), steering, and braking is carried out automatically without requiring operations made by a driver. The ECU 20 can also execute travel assistance control, such as, for example, collision mitigation braking and lane keep assistance, during manual driving. Collision mitigation braking assists in avoiding collisions by instructing a brake device 51 to operate when there is an increased likelihood of colliding with an obstruction in front. Lane keep assistance assists in preventing the vehicle V from departing the travel lane by instructing an electric power steering device 41 to operate when there is an increased likelihood of the vehicle the departing from the travel lane. Additionally, the ECU 20 can execute automatic following control that causes the vehicle V to automatically follow a forward vehicle, both during automated driving and manual driving. During automated driving, the acceleration, deceleration, and steering of the vehicle V may all be performed automatically. During manual driving, the acceleration and deceleration of the vehicle V may be performed automatically.

The ECU 21 is an environment recognition unit that recognizes the travel environment of the vehicle V on the basis of detection results from detecting units 31A, 31B, 32A, and 32B that detect surrounding conditions of the vehicle V. In the present embodiment, the detecting units 31A and 31B are cameras that capture an image to the front of the vehicle V (these may be called a “camera 31A” and a “camera 31B” hereinafter). By analyzing the images captured by the camera 31A and the camera 31B, the contours of objects can be extracted, lane dividing lines on the road (white lines and the like) can be extracted, and so on.

In the present embodiment, the detecting unit 32A is LIDAR (Light Detection and Ranging) (this may be called “LIDAR 32A” hereinafter), and detects objects in the periphery of the vehicle V, measures the distance to objects, and so on. In the present embodiment, five of the LIDAR 32A are provided: one on each front corner of the vehicle V, one in the rear center, and one each on the rear sides of the vehicle V. The detecting unit 32B is millimeter wave radar (also called “radar 32B” hereinafter), which detects objects in the periphery of the vehicle V, measures the distances to those objects, and so on. In the present embodiment, five of the radar 32B are provided: one in the front-center of the vehicle V, as well as one each on the front and rear corners of the vehicle V.

The ECU 22 is a steering control unit that controls the electric power steering device 41. The electric power steering device 41 includes a mechanism for turning the front wheels in response to a driver making a driving operation (turning operation) on a steering wheel ST. The electric power steering device 41 includes: a drive unit 41a including a motor that produces drive power (also called “steering assist torque”) for assisting turning operations or automatically steering the front wheels; a steering angle sensor 41b; a torque sensor 41c that detects steering torque imparted on the driver (also called “steering load torque”; different from the steering assist torque); and the like. The ECU 22 can obtain detection results from a sensor 36 that detects whether or not the driver is gripping the steering wheel ST, and can therefore monitor a state of the grip of the driver.

The ECU 23 is a braking control unit that controls a hydraulic device 42. A braking operation made by the driver on the brake pedal BP is transformed into hydraulic pressure in the brake master cylinder BM and then transmitted to the hydraulic device 42. The hydraulic device 42 is an actuator capable of controlling the hydraulic pressure of operating fluid supplied to brake devices (e.g., disk brake devices) 51 provided in each of the four wheels on the basis of the hydraulic pressure transmitted from the brake master cylinder BM, and the ECU 23 controls the driving of solenoid valves and the like provided in the hydraulic device 42. During braking, the ECU 23 can light a brake lamp 43B. This makes it possible to prompt a following vehicle to pay more attention to the vehicle V.

The ECU 23 and the hydraulic device 42 can constitute an electric servo brake. The ECU 23 can, for example, control the distribution between braking force from the four brake devices 51 and braking force from regenerative braking performed by a motor included in the power plant 50. The ECU 23 can also implement an ABS function, traction control, and an attitude control function of the vehicle V are implemented on the basis of detection results from a wheel speed sensor 38 provided in each of the four wheels, a yaw rate sensor (not shown), and a pressure sensor 35 that detects the pressure in the brake master cylinder BM.

The ECU 24 is a stop maintenance control unit that controls an electric parking brake device (e.g., a drum brake) 52 provided in a rear wheel. The electric parking brake device 52 includes a mechanism that locks the rear wheel. The ECU 24 can control the electric parking brake device 52 to lock and unlock the rear wheel.

The ECU 25 is a vehicle interior notification control unit that controls an information output device 43A which provides information in the vehicle. The information output device 43A includes a heads-up display, a display device provided in the instrument panel, or the like, an audio output device, or the like, for example. A vibrating apparatus may be included as well. The ECU 25 causes the information output device 43A to output various types of information such as vehicle speed and outside temperature, information such as route guidance information, information pertaining to the state of the vehicle V, and the like, for example.

The ECU 26 includes a communication device 26a for vehicle-to-vehicle communication. The communication device 26a communicates wirelessly with other vehicles in the periphery, and exchanges information with those vehicles.

The ECU 27 is a drive control unit that controls the power plant 50. Although the one ECU 27 is assigned to the power plant 50 in the present embodiment, one ECU may be assigned to each of the internal combustion engine, the motor, and the automatic transmission. The ECU 27 controls outputs of the internal combustion engine and the motor, switches the gear ratio of the automatic transmission, and so on in accordance with a driving operation made by the driver, the vehicle speed, and the like detected by an operation detecting sensor 34a provided in an accelerator pedal AP, an operation detecting sensor 34b provided in the brake pedal BP, and so on, for example. Note that a rotation number sensor 39 that detects the number of rotations of an output shaft of the automatic transmission is provided in the automatic transmission as a sensor that detects a travel state of the vehicle V. The vehicle speed of the vehicle V can be calculated from a detection result from the rotation number sensor 39.

The ECU 28 is a position recognition unit that recognizes the current position, path, and so on of the vehicle V. The ECU 28 controls a gyrosensor 33, a GPS sensor 28b, and a communication device 28c, and processes information of detection results or communication results therefrom. The gyrosensor 33 detects rotational movement of the vehicle V. The path of the vehicle V can be determined from the detection results from the gyrosensor 33. The GPS sensor 28b detects the current position of the vehicle V. The communication device 28c communicates wirelessly with a server that provides map information, traffic information, and the like, and obtains that information. A database 28a can store highly-accurate map information, and the ECU 28 can specify the position of the vehicle V in a lane with a high level of accuracy on the basis of this map information and the like.

An input device 45 is disposed within the vehicle so as to be operable by an occupant, and receives instructions, information, and the like input from the occupant.

### Example of Control

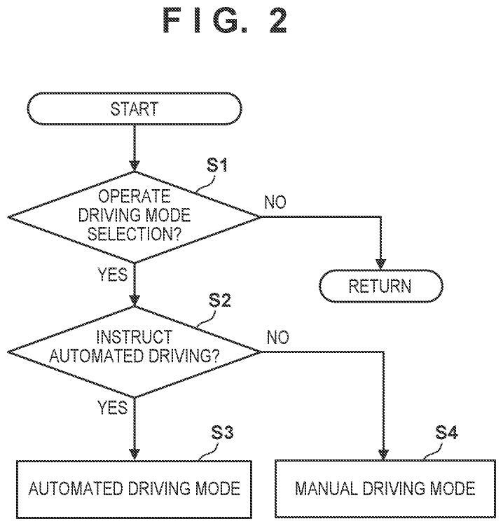

An example of control performed by the control device 1 will be described. FIG. 2 is a flowchart illustrating mode selection processing for driving control executed by the ECU 20.

In step S1, it is determined whether or not an occupant has made a mode selection operation. For example, the occupant can make an instruction to switch between an automated driving mode and a manual driving mode by operating the input device 45. The sequence moves to step S2 when a selection operation has been made, whereas the processing ends when no selection operation has been made.

In step S2, it is determined whether or not the selection operation is an operation instructing automated driving; the sequence moves to step S3 when the operation instructs automated driving, and to step S4 when the operation instructs manual driving. In step S3, the automated driving mode is set, and automated driving control is started. In step S4, the manual driving mode is set, and manual driving control is started. The current setting with respect to the driving control mode is communicated to the ECUs 21 to 28 from the ECU 20 and recognized.

In the automated driving control, the ECU 20 controls the steering, braking, and driving of the vehicle V by outputting control commands to the ECU 22, the ECU 23, and the ECU 27, and causes the vehicle V to travel automatically without requiring the occupant to perform driving operations. The ECU 20 sets a travel path for the vehicle V, and causes the vehicle V to travel along the set travel path by referring to position recognition results from the ECU 28, object recognition results, and the like. Objects are recognized on the basis of detection results from the detecting units 31A, 31B, 32A, and 32B. In the manual driving control, the driving, steering, and braking of the vehicle V is performed in accordance with driving operations performed by the driver, and the ECU 20 executes travel assistance control as appropriate.

### Vehicle-To-Vehicle Communication

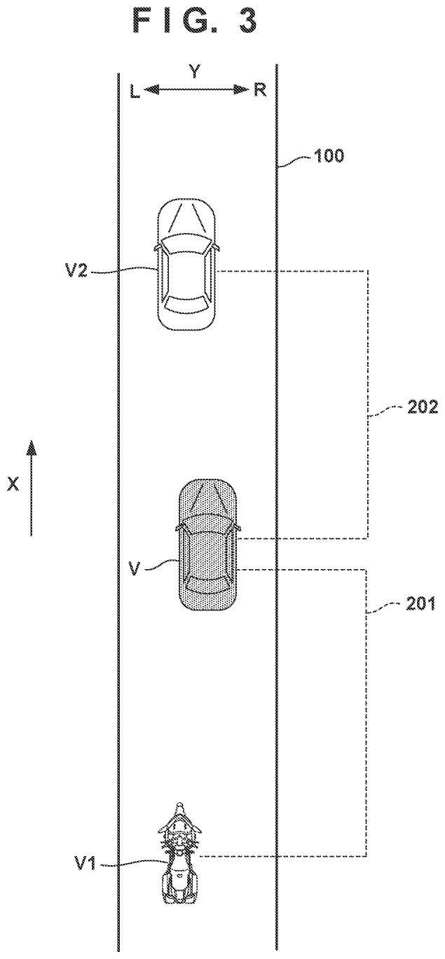

FIG. 3 is a diagram illustrating an example of vehicle-to-vehicle communication performed by the ECU 26. As an example, FIG. 3 illustrates a state in which the vehicle V, which is a self-vehicle, and vehicles V1 and V2, which are other vehicles, are traveling in the same travel path 100. The arrow X indicates a travel direction of the vehicles V, V1, and V2, and corresponds to a lengthwise direction of the travel path 100. The arrow Y indicates a road width direction, where “R” indicates the right side and “L” indicates the left side.

The vehicle V1 is a rear vehicle present behind the vehicle V. In the example illustrated here, the vehicle V1 is a two-wheeled automobile. The vehicle V2 is a forward vehicle present in front of the vehicle V. In the example illustrated here, the vehicle V2 is a four-wheeled automobile, and is a vehicle capable of automated driving that includes the same kind of control device as the control device 1 included in the vehicle V.

The vehicle V is capable of two-way communication with the vehicle V2 by establishing a communication link 202 with the vehicle V2 using the ECU 26. Additionally, the vehicle V is capable of two-way communication with the vehicle V1 by establishing a communication link 201 with the vehicle V1 using the ECU 26. Note that the positions of the other vehicles V1 and V2 in the travel direction X, the road width direction Y, and so on can be recognized by obtaining current position information from the other vehicles V1 and V2. Likewise, four-wheeled vehicles and two-wheeled vehicles can be distinguished from each other by obtaining vehicle type information from the other vehicles V1 and V2.

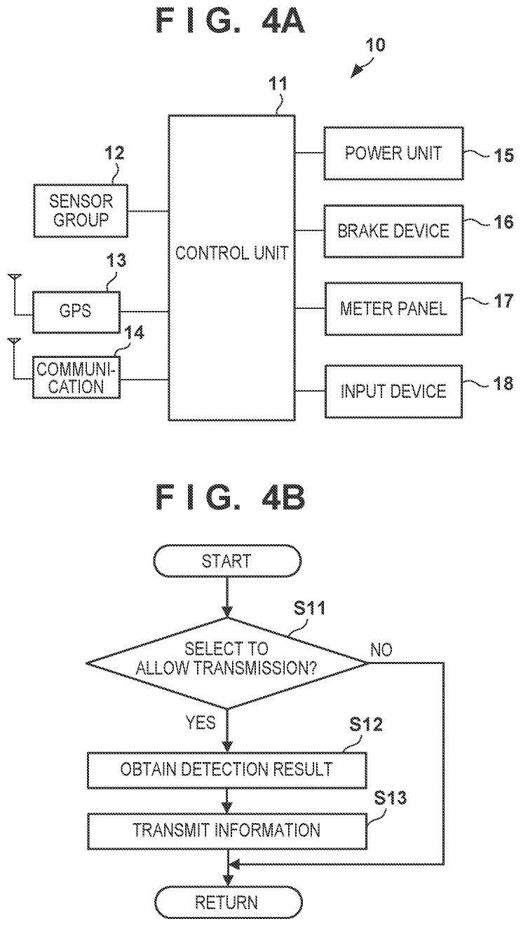

FIG. 4A is a block diagram illustrating a control device 10 of the vehicle V1. The control device 10 includes a control unit (ECU) 11. The control unit 11 includes a processor such as a CPU, a storage device such as semiconductor memory, an input/output interface or a communication interface with external devices, and the like. The storage device stores programs executed by the processor, the data used in processing by the processor, and so on. The control unit 11 may include a plurality of sets of processors, storage devices, interfaces, and the like corresponding to each function of the vehicle V1.

The control unit 11 can obtain detection results from a sensor group 12. The sensor group 12 includes, for example, a steering angle sensor that detects a steering angle of the vehicle V1 (a sensor that detects an angle to which the handlebar is turned), a vehicle speed sensor that detects the vehicle speed, a bank angle sensor that detects a bank angle (left-right tilt in a two-wheeled vehicle), and the like. The control unit 11 also obtains information from a GPS sensor 13 and a communication device 14 for vehicle-to-vehicle communication. The GPS sensor 13 detects the current position of the vehicle V1. The communication device 14 communicates wirelessly with other vehicles in the periphery, and exchanges information with those vehicles.

The control unit 11 can control various actuators and a power unit 15, a brake device 16, and the like. The power unit 15 is a unit that provides propulsion power for the vehicle V1, and is typically an internal combustion engine. However, the power unit 15 is a motor for travel when the vehicle V1 is an electric vehicle. The brake device 16 is a device that applies braking force to the front wheel and the rear wheel of the vehicle V1. The control unit 11 controls the power unit 15, the brake device 16, and the like in accordance with detection results from the sensor group 12 and the like in order to assist an occupant (rider) with driving operations.

The control unit 11 is also capable of controlling a display made in an instrument panel 17. The control unit 11 is electrically connected to an input device 18. The input device 18 is buttons or a touch panel for accepting various types of construction operations from the occupant.

### Passing Allowance Control

Vehicles with narrow vehicle widths, such as two-wheeled vehicles, often overtake four-wheeled vehicles that are moving slowly or stopped. In terms of the example in FIG. 3, the vehicle V may be overtaken by the vehicle V1 behind the vehicle V. In such a case, having the vehicle V, which is performing automated driving, move in the road width direction to provide travel space for the vehicle V1 makes it easier for the rear vehicle V1, which is hurrying to its destination, to travel smoothly. In the present embodiment, vehicle-to-vehicle communication is used to perform control for allowing a rear vehicle to pass when the vehicle V is performing automated driving.

Processing performed by the rear vehicle will be described first. FIG. 4B is a flowchart illustrating an example of processing performed by the control unit 11. The example illustrated here is an example of processing performed when the control unit 11 transmits information of the vehicle V1 to other vehicles in the periphery (and specifically, the vehicle V traveling in front), and is executed periodically. In the present embodiment, information pertaining to a travel trajectory of the vehicle V1 is transmitted.

In step S11, it is determined whether or not the occupant has selected to allow transmission. By operating the input device 18, the occupant can select whether or not to transmit information pertaining to the travel trajectory of the vehicle V1 to other vehicles. Depending on the occupant of the vehicle V1, the occupant may not desire to perform passing allowance control for the vehicle V. The occupant can therefore choose not to allow the transmission. The sequence moves to step S12 when allowing the transmission is selected, and ends when the transmission is not allowed.

In step S12, detection results are obtained from the sensors (12, 13). In step S13, a communication link is established with the other vehicle (the vehicle V), and information pertaining to the travel trajectory of the vehicle V1, including the detection results obtained in step S12, is transmitted. Identification information, a vehicle type (two-wheeled), the current position, the vehicle speed, the steering angle, and the bank angle of the vehicle V1 can be given as examples of the information pertaining to the travel trajectory.

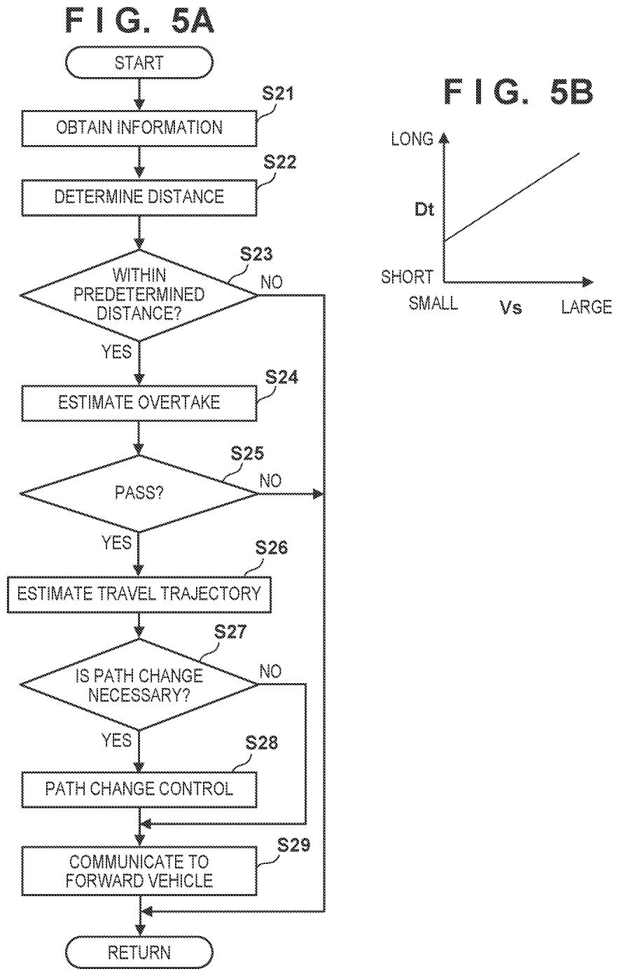

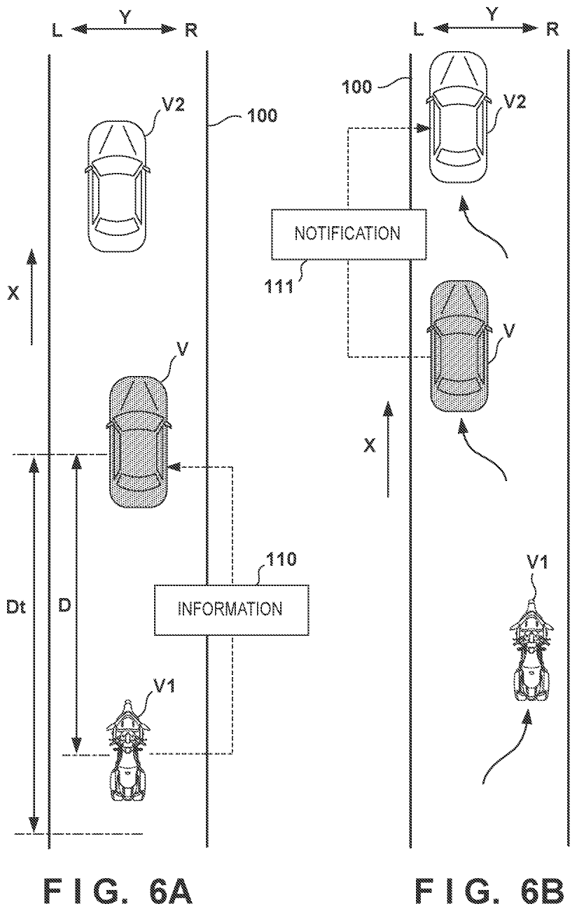

An example of control performed during automated driving by the vehicle V will be described next with reference to FIGS. 5A to 6B. FIG. 5A is a flowchart illustrating an example of processing executed by the ECU 20 of the control device 1. The example illustrated here is an example of passing allowance control executed periodically by the control device 1. FIGS. 6A and 6B are explanatory diagrams illustrating behavior of the vehicles V, V1, and V2.

In step S21, the ECU 20 obtains the information pertaining to the travel trajectory, received from the vehicle V1 by the ECU 26. FIG. 6A schematically illustrates the control device 1 of the vehicle V receiving information 110 pertaining to the travel trajectory from the control device 10 of the vehicle V1.

In step S22, the ECU 20 makes a determination pertaining to a distance between the self-vehicle V and the rear vehicle V1 on the basis of the information 110 obtained in step S21. In the present embodiment, to avoid performing unnecessary control, control is performed for providing travel space for the vehicle V1 at a stage where the rear vehicle V1 has approached the self-vehicle V. Here, it is confirmed whether or not the rear vehicle V1 is present within a predetermined distance Dt from the self-vehicle V. As illustrated in FIG. 6A, the distance Dt is a distance to the rear of the self-vehicle V as seen in the travel direction X. A distance D represents a distance between the self-vehicle V and the rear vehicle V1, and can be calculated from the current position of the self-vehicle V the and the current position of the rear vehicle V1.

The distance Dt may be a fixed value or a variable value. When the distance Dt is a variable value, the distance Dt may be set to be greater when a relative speed Vs, calculated by subtracting the vehicle speed of the self-vehicle V from the vehicle speed of the rear vehicle V1, is greater than when the relative speed Vs is lower. FIG. 5B is a graph illustrating an example of such a setting. In the example illustrated here, the horizontal axis represents the relative speed Vs, and the vertical axis represents the distance Dt. The distance Dt is set to be greater as the relative speed Vs increases (the speed of the rear vehicle V1 is faster). Although the distance Dt changes in a linear manner with respect to the relative speed Vs, the change is not limited thereto, and the distance Dt may change in steps with respect to the relative speed Vs. When, the distance Dt changes in steps, the distance Dt may change in at least two steps.

In step S23 of FIG. 5A, the ECU 20 determines, on the basis of the determination in step S22, whether the distance D≤the distance Dt. The sequence moves to step S24 when the distance D≤the distance Dt, and the processing ends when the distance D>the distance Dt.

In step S24, the ECU 20 estimates whether or not the rear vehicle V1 will pass the self-vehicle V on the basis of the information 110 obtained in step S21. For example, it is estimated that the rear vehicle V1 will pass the self-vehicle V when the relative speed Vs>a threshold, and it is estimated that the rear vehicle V1 will not pass the self-vehicle V when the relative speed Vs is ≤ the threshold. If in step S25 the ECU 20 estimates that the rear vehicle V1 will pass the self-vehicle V on the basis of the result of the estimation performed in step S24, the sequence moves to step S26, whereas if it is estimated at the rear vehicle V1 will not pass, the processing ends.

In step S26, the ECU 20 estimates the travel trajectory of the rear vehicle V1 on the basis of the information 110 obtained in step S21. In other words, it is estimated whether the rear vehicle V1 will pass the self-vehicle V on the right side or on the left side. For example, the current position information, the steering angle information, and the bank angle information included in the information 110 can be used for this estimation.

In the current position information, if the rear vehicle V1 is located on the right side in the Y direction, it is highly likely that the rear vehicle V1 will pass the self-vehicle V on the right side. Conversely, if the rear vehicle V1 is located on the left side in the Y direction, it is highly likely that the rear vehicle V1 will pass the self-vehicle V on the left side.

In the steering angle information, if the rear vehicle V1 is steering to the right in the Y direction, it is highly likely that the rear vehicle V1 will pass the self-vehicle V on the right side. Conversely, if the rear vehicle V1 is steering to the left in the Y direction, it is highly likely that the rear vehicle V1 will pass the self-vehicle V on the left side.

In the bank angle information, if the rear vehicle V1 is tilting to the right, it is highly likely that the rear vehicle V1 will pass the self-vehicle V on the right side. Conversely, if the rear vehicle V1 is tilting to the left, it is highly likely that the rear vehicle V1 will pass the self-vehicle V on the left side.

All three, or only two or one, of the current position information, the steering angle information, and the bank angle information may be used to estimate the travel trajectory. Using a greater number of pieces of information increases the estimation accuracy. When the travel trajectory is estimated using a plurality of pieces of information, the steering angle information or the bank angle information may be given a greater weight than the current position information.

In step S27, the ECU 20 compares the travel trajectory of the rear vehicle V1 estimated in step S26 with the current position of the self-vehicle V in the road width direction Y, and determines whether or not it is necessary for the self-vehicle V to change its path. When it is determined that a path change is necessary, the sequence moves to step S28, whereas when it is determined that a path change is not necessary, the sequence moves to step S29.

It is determined that a path change is not necessary, for example, when the self-vehicle V is traveling on the left side of the travel path 100 and the travel trajectory of the rear vehicle V1, estimated in step S26, is the right side of the travel path 100. It is determined that a path change to the left is necessary, for example, when the self-vehicle V is traveling on the right side of the travel path 100 and the travel trajectory of the rear vehicle V1, estimated in step S26, is the right side of the travel path 100.

It is determined that a path change to the left is necessary, for example, when the self-vehicle V is traveling in the center of the travel path 100 and the travel trajectory of the rear vehicle V1, estimated in step S26, is the right side of the travel path 100. When the self-vehicle V is traveling in the center of the traveling 100, it is determined that a path change is necessary when the width of the travel path 100 is less than a threshold, and it is determined that a path change is not necessary when the width of the travel path 100 is greater than or equal to the threshold.

In step S28, the ECU 20 performs control for changing the path of the self-vehicle V. Here, the ECU 22 is instructed to perform steering control to position the self-vehicle V on the opposite side, in the road width direction Y, from the rear vehicle V1 estimated in step S26. FIG. 6B illustrates an example thereof. In the example illustrated here, the rear vehicle V1 has changed paths to the right side of the travel path 100, and the self-vehicle V has changed paths to the left so as to provide space in front of the rear vehicle V1. This makes it easier for the rear vehicle V1 to pass the self-vehicle V.

Note that the ECU 20 performs the path change in the road width direction Y within the travel path 100 in this manner while the self-vehicle V is traveling, and thus the self-vehicle V continues traveling rather than stopping. Although it is also possible to use control which stops the self-vehicle V, doing so delays the self-vehicle V from reaching its destination. Accordingly, in the present embodiment, the self-vehicle V continues traveling rather than stopping.

In step S29 in FIG. 5A, the ECU 20 uses the ECU 26 to establish a communication link with the forward vehicle V2 traveling in front of the self-vehicle V, and makes a notification to the forward vehicle V2 to vacate the travel trajectory of the vehicle V1 estimated in step S27. This notification increases the likelihood that the control device of the forward vehicle V2 will change its path as necessary to vacate the travel trajectory of the vehicle V1. FIG. 6B illustrates an example thereof. In the example illustrated here, a notification 111 is transmitted from the self-vehicle V1 to the forward vehicle V2. In response to this notification 111, the forward vehicle V2 changes its path to the left so as to provide space in front of the rear vehicle V1. This makes it easier for the rear vehicle V1 to pass not only the self-vehicle V, but also the forward vehicle V2.

Although FIG. 6B illustrates an example in which there is only one forward vehicle V2 in front of the self-vehicle V, the notification 111 may be transmitted to a plurality of forward vehicles. In this case, the notification 111 may be transmitted to forward vehicles located within a predetermined distance in front of the self-vehicle V.

### Second Embodiment

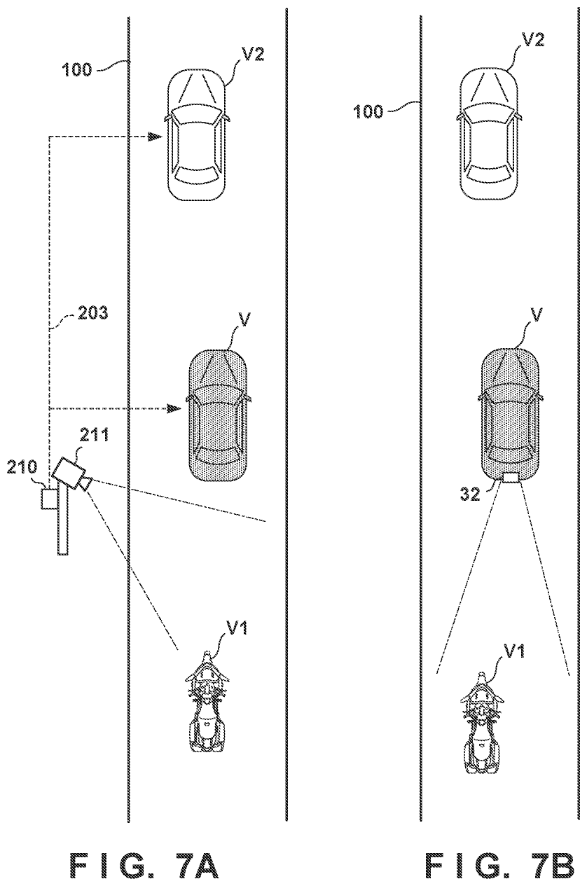

Vehicle-to-vehicle communication was used in the first embodiment. However, road-to-vehicle communication may be used. FIG. 7A illustrates an example thereof. This drawing illustrates an example of a central management device 210 which provides information to the respective vehicles on the basis of images captured by a surveillance camera device 211. The central management device 210 is, for example, a server computer capable of communicating wirelessly with the control devices of the respective vehicles. The central management device 210 generates information pertaining to the travel trajectory of the rear vehicle V1 from an image captured of the rear vehicle V1, and provides that information to the vehicle V, the forward vehicle V2, and so on. With this configuration, the same control as that described in the first embodiment can be performed by the control devices of the vehicle V, the forward vehicle V2, and so on, even if the rear vehicle V1 does not have a communication function.

### Third Embodiment

Vehicle-to-vehicle communication was used in the first embodiment. However, the information pertaining to the travel trajectory of the rear vehicle V1 may be obtained from detection results from the detecting units included in the self-vehicle V. FIG. 7B illustrates an example thereof. In the example illustrated here, the rear vehicle V1 is detected by a detecting unit 32 of the self-vehicle V, and information pertaining to the travel trajectory of the rear vehicle V1 is generated. The information can be generated by the ECU 21, and the detecting unit 32 is, for example, the above-described LIDAR 32A, millimeter wave radar, or the like. The detecting unit 32 may be a camera, or the detecting unit 32 may be a combination of these.

### Summary of Embodiments

1. A vehicle control device (1) according to the foregoing embodiments is a vehicle control device mounted on a first vehicle (V) and capable of causing the first vehicle to travel using automated driving, and includes: a trajectory information obtaining unit (20, S21) configured to obtain information pertaining to a travel trajectory of a second vehicle behind the first vehicle; and a control unit (20, S29) configured to control a position of the first vehicle to a side opposite from the travel trajectory in a road width direction on the basis of the information obtained by the trajectory information obtaining unit.

According to this embodiment, it can be made easier for a vehicle behind a self-vehicle hurrying to its destination to travel smoothly.

2. The vehicle control device (1) according to the foregoing embodiments further includes a notifying unit (20, S29) configured to notify a third vehicle in front of the first vehicle to vacate the travel trajectory.

According to this embodiment, it can be made easier for the vehicle behind the self-vehicle hurrying to its destination to travel even more smoothly.

3. In the foregoing embodiments, the control unit controls (20, S23, S27) the position of the first vehicle when a distance between the second vehicle and the first vehicle is within a predetermined distance (Dt), and the predetermined distance is set to be longer as a relative speed calculated by subtracting a vehicle speed of the first vehicle from a vehicle speed of the second vehicle increases (FIG. 5B).

According to this embodiment, the self-vehicle can be controlled in accordance with the speed of the vehicle behind the self-vehicle.

4. In the foregoing embodiments, the information is information including at least a steering angle of the second vehicle.

According to this embodiment, the travel trajectory of the vehicle behind the self-vehicle can be estimated more accurately.

5. In the foregoing embodiments, the information is information including at least a position of the second vehicle.

According to this embodiment, the travel trajectory of the vehicle behind the self-vehicle can be estimated more accurately.

6. In the foregoing embodiments, when the second vehicle is a two-wheeled vehicle, the information is information including at least a bank angle.

According to this embodiment, the travel trajectory of the vehicle behind the self-vehicle can be estimated more accurately.

7. The vehicle control device (1) according to the foregoing embodiments further includes an estimating unit (20, S24) configured to estimate whether or not the second vehicle will pass the first vehicle, wherein the control unit controls (20, S25, S28) the position of the first vehicle when the estimating unit has estimated that the second vehicle will pass the first vehicle.

According to this embodiment, it is possible to ensure that the path of the self-vehicle is not changed unnecessarily.

8. In the foregoing embodiments, when the first vehicle is traveling, the control unit causes the first vehicle to continue traveling while controlling the position of the first vehicle to the side opposite from the travel trajectory in the road width direction.

According to this embodiment, having the first vehicle continue to travel makes it possible to prevent the first vehicle from reaching its destination extremely late.

9. A vehicle control device (10) according to the foregoing embodiments includes: a transmitting unit (14, S13) configured to transmit information pertaining to a travel trajectory of a self-vehicle to a forward vehicle (V), which includes the above-described vehicle control device (1), in front of the self-vehicle; and a selecting unit (18, S11) configured to enable an occupant to select whether or not the transmitting unit is to transmit the information.

According to this embodiment, the occupant can make this selection when it is not necessary to take vehicles in front of the self-vehicle into account.

Although embodiments of the invention have been described above, the invention is not limited to the foregoing embodiments, and many changes and variations are possible within the scope of the essential spirit of the invention.

What is claimed is:

1. A vehicle control device mounted on a first vehicle and capable of causing the first vehicle to travel by automated driving, the device comprising:
a trajectory information obtaining unit configured to obtain information pertaining to a travel trajectory of a second vehicle behind the first vehicle; and
a control unit configured to control a position of the first vehicle to a side opposite from the travel trajectory in a road width direction on the basis of the information obtained by the trajectory information obtaining unit.

2. The vehicle control device according to claim 1, further comprising:
a notifying unit configured to notify a third vehicle in front of the first vehicle to vacate the travel trajectory.

3. The vehicle control device according to claim 1,
wherein the control unit controls the position of the first vehicle when a distance between the second vehicle and the first vehicle is within a predetermined distance, and
the predetermined distance is set to be longer as a relative speed calculated by subtracting a vehicle speed of the first vehicle from a vehicle speed of the second vehicle increases.

4. The vehicle control device according to claim 1,
wherein the information is information including at least a steering angle of the rear vehicle.

5. The vehicle control device according to claim 1,
wherein the information is information including at least a position of the second vehicle.

6. The vehicle control device according to claim 1,
wherein when the second vehicle is a two-wheeled vehicle, the information is information including at least a bank angle.

7. The vehicle control device according to claim 1, further comprising:
an estimating unit configured to estimate whether or not the second vehicle will pass the first vehicle,
wherein the control unit controls the position of the first vehicle when the estimating unit has estimated that the second vehicle will pass the first vehicle.

8. The vehicle control device according to claim 1,
wherein when the first vehicle is traveling, the control unit causes the first vehicle to continue traveling while controlling the position of the first vehicle to the side opposite from the travel trajectory in the road width direction.

9. A vehicle control device comprising:
a transmitting unit configured to transmit information pertaining to a travel trajectory of a self-vehicle to a vehicle, which includes a vehicle control device according to claim 1, in front of the self-vehicle; and
a selecting unit configured to enable an occupant to select whether or not the transmitting unit is to transmit the information.
